(19) United States
(12) Patent Application Publication
(10) Pub. No.: US 2016/0053668 A1
(43) Pub. Date: Feb. 25, 2016

(54) PRECHAMBER ASSEMBLY FOR ENGINE

(71) Applicant: Caterpillar Inc., Peoria, IL (US)

(72) Inventors: Andrew J. Loetz, West Lafayette, IN (US); Joel D. Hiltner, Bellingham, WA (US)

(73) Assignee: Caterpillar Inc., Peoria, IL (US)

(21) Appl. No.: 14/929,440

(22) Filed: Nov. 2, 2015

(51) Int. Cl. F02B 19/10; F02B 19/18; F02B 19/12

(52) U.S. Cl. CPC F02B 19/1085; F02B 19/12; F02B 19/18

(57) ABSTRACT

A prechamber assembly for an engine is provided. The prechamber assembly includes a prechamber located upstream of a main combustion chamber and adapted to receive fuel from a fuel supply system of the engine. The prechamber includes a first portion, a taper portion, and a second portion. The prechamber assembly further includes a fuel injection member located downstream of the taper portion of the prechamber and fluidly connected to the second portion of the prechamber. The fuel injection member is inclined at an angle with respect to a central axis of the prechamber. The fuel injection member is in electric communication with a controller. The controller is configured to actuate the fuel injection member to supply the fuel into the second portion of the prechamber to provide rich mixing of the fuel with an air-fuel mixture received from the main combustion chamber during operation of the engine.

### TECHNICAL FIELD

The present disclosure relates to an engine, and more particularly relates to a prechamber assembly for the engine.

### BACKGROUND

Generally, in order to improve utilization of fuel, an auxiliary chamber, generally referred to as a pre-combustion chamber or a prechamber, is provided in a cylinder head of the engine. The prechamber is coupled to the cylinder head in a manner, such that the prechamber is in fluid communication with the combustion chamber of the engine. Accordingly, in the case of indirect injection, a fuel injector is disposed in the prechamber to spray fuel into the prechamber, where the fuel mixes with the air to form the air-fuel mixture. Further, an ignition initiation device, such as a spark plug or a glow plug, is also disposed in the prechamber to initiate the combustion of the air-fuel mixture in the prechamber. As such, the combustion initiates in the prechamber and subsequently proceeds to the combustion chamber. Therefore, volume of the prechamber adds to the volume of the combustion chamber, thereby providing a large volume for the combustion of the air-fuel mixture. However, in order to minimize the amount of particulate matter in exhaust from the engine, it should be ensured that all fuel present in the air-fuel mixture is combusted. Accordingly, the air-fuel mixture supplied into the prechamber needs to be combusted before entering a main combustion chamber of the engine.

U.S. Pat. No. 2,336,883 A ('883 patent) describes a prechamber of an engine. In particular, the '883 patent describes an engine of the compression-ignition fuel injection type having a cylinder, a piston working therein, and a head closing one end thereof. The head also has a compression space comprising a vortex chamber communicating with the apex of the recess. The head further includes a swirl chamber axially adjacent but slightly transversely offset from the vortex chamber and communicating therewith through a restricted passage. Further a funnel-like space is provided between the vortex chamber and the swirl chamber and is disposed in the region of the restricted passage for simultaneously injecting fuel into the vortex and the swirl chambers at substantial angles to the path of compressed fluid traversing the same. However, the '883 patent is silent on the mixing of air-fuel mixture that is supplied into the main combustion chamber of the engine.

### SUMMARY OF THE DISCLOSURE

According to an aspect of the present disclosure, a prechamber assembly for an engine is disclosed. The prechamber assembly includes a prechamber located upstream of a main combustion chamber defined in a cylinder of the engine. The prechamber is adapted to receive fuel from a fuel supply system of the engine. The prechamber includes a first portion having a first diameter, a taper portion extending from the first portion, and a second portion having a second diameter. The second portion is extending from the taper portion and the second diameter is smaller than the first diameter. The second portion includes an opening to supply the fuel into the main combustion chamber. The prechamber assembly further includes a fuel injection member located downstream of the taper portion of the prechamber and is fluidly connected to the second portion of the prechamber. The fuel injection member is in communication with the fuel supply system and the fuel injection member is inclined at an angle with respect to a central axis of the prechamber. The fuel injector is in electric communication with a controller, the controller configured to supply the fuel into the second portion of the prechamber to provide rich mixing of the fuel with an air-fuel mixture received from the main combustion chamber during operation of the engine. Further, the prechamber assembly includes a spark plug located upstream of the taper portion of the prechamber and connected to the first portion of the prechamber.

Other features and aspects of this disclosure will be apparent from the following description and the accompanying drawings.

### BRIEF DESCRIPTION OF THE DRAWINGS

FIG. 1 illustrates a cross-section of a cylinder head of an engine equipped with a prechamber assembly, according to one embodiment of the present disclosure; and

FIG. 2 illustrates an enlarged view of the prechamber assembly of FIG. 1, according to one embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

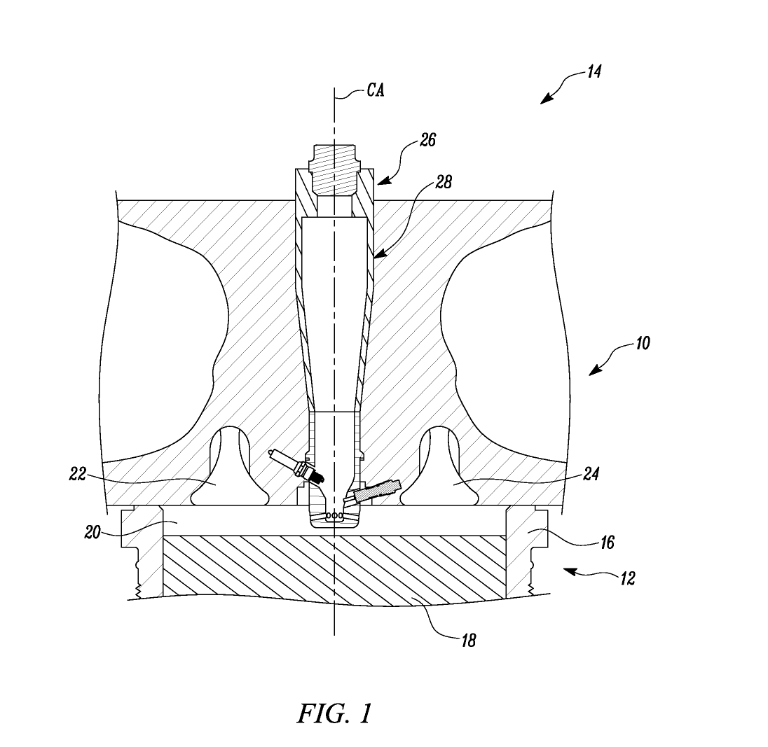

FIG. 1 illustrates a partial sectional view of a cylinder head 10 and a cylinder block 12 of an engine 14. The cylinder head 10 is mounted on the cylinder block 12. The engine 14 is a gas engine. In an example, the engine 14 may embody a compression ignition engine, a spark-ignition engine, or any type of combustion engine known in the art. The cylinder block 12 includes multiple cylinders 16. A cross-section of one of the multiple cylinders 16 is shown in FIG. 1. The multiple cylinders 16 may be arranged in an inline configuration, a radial configuration, or any other configurations known in the art. The cylinder block 12 includes a piston 18 disposed within the cylinder 16.

The piston 18 reciprocates between a bottom dead center (BDC) to a top dead center (TDC) in one stroke. One cycle of an operation of the engine 14 includes various strokes, such as suction stroke, compression stroke, expansion stroke and exhaust stroke. A volume between the TDC and the BDC defines a swept volume. The swept volume is indicative of a volume available for a combusted charge to occupy. The phrase “charge” herein may be referred to either as air or a mixture of air and fuel. At TDC of the piston 18, a volume available between the piston 18 and an inner portion of the cylinder head 10 is defined as a main combustion chamber 20.

The cylinder head 10 includes an inlet valve 22 for introducing the charge into the cylinder 16. The cylinder head 10 also includes an inlet port (not shown) to allow the charge into the cylinder 16. Once the charge is combusted in the main combustion chamber 20, the products of the combustion are forced out of the cylinder 16 during the exhaust stroke of the engine 14 via an exhaust valve 24. The engine 14 further includes a fuel supply system 26. The fuel supply system 26 includes a prechamber assembly 28 enclosed within the cylinder head 10. The prechamber assembly 28 is provided in the cylinder head 10 to increase a volume of the main combustion chamber 20. In an example, a combustion initiation device, such as a spark plug or a fuel injector, is disposed in the main combustion chamber 20. In such cases, the prechamber assembly 28 increases volume of the main combustion chamber 20, whilst accommodating the combustion initiation device.

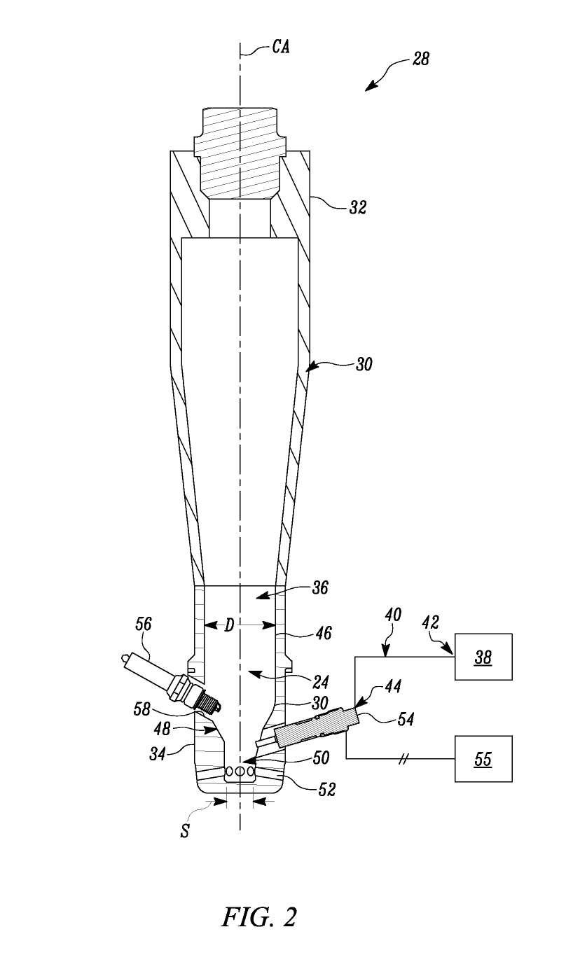

FIG. 2 illustrates an enlarged cross-sectional view of the prechamber assembly 28. The prechamber assembly 28 includes a housing member 30 enclosed within the cylinder head 10. The housing member 30 has a top end 32 and a bottom end 34. The housing member 30 is coupled to the cylinder head 10 using fastening members (not shown). Specifically, the top end 32 of the prechamber assembly 28 is coupled to the cylinder head 10. The prechamber assembly 28 includes a prechamber 36 defined within the housing member 30 adjacent to the bottom end 34 thereof. The prechamber 36 is located upstream of the main combustion chamber 20 defined in the cylinder 16 of the engine 14. The prechamber assembly 28 is in fluid communication with the fuel supply system 26 of the engine 14. The fuel supply system 26 includes a reservoir 38 and a fuel supply line 40. A first end 42 of the fuel supply line 40 is connected to an outlet (not shown) of the reservoir 38 and a second end 44 of the fuel supply line 40 is connected to an inlet of the prechamber assembly 28. The prechamber 36 includes a first portion 46 defined within the prechamber 36. The first portion 46 extends along a central axis “CA” of the prechamber 36 and has a first diameter “D”. The prechamber 36 further includes a taper portion 48 extending from the first portion 46. The prechamber 36 further includes a second portion 50 having a second diameter “S”. The second diameter “S” is smaller than the first diameter “D”. The second portion 50 extends from the taper portion 48. The second portion 50 includes an opening 52 to supply air-fuel mixture from the main combustion chamber 20 to the prechamber 36.

The prechamber assembly 28 further includes a fuel injection member 54 located downstream of the taper portion 48 of the prechamber 36. The fuel injection member 54 is in fluid communication with the second portion 50 of the prechamber 36. The fuel injection member 54 is in fluid communication with the fuel supply system 26. The fuel injection member 54 is inclined at an angle with respect to the central axis “CA” of the prechamber 36. In an example, the fuel injection member 54 may be inclined at an angle in a range of about 10 degrees to about 80 degrees. The fuel injection member 54 is in electric communication with a controller 55, and the controller 55 is adapted to control supply of the fuel into the second portion 50 of the prechamber 36 to provide a rich mixing of the fuel with an air-fuel mixture received from the main combustion chamber 20 during operation of the engine 14.

Further, the manner of fuel injection may either be mechanical injection or electronic injection. It will be understood by the person skilled in the art that the fuel injection may be assisted by a fuel pump, a fuel accumulator, a fuel filter, and a fuel distributor, that are not shown in this disclosure. Accordingly, the prechamber assembly 28 may be coupled to one or more of these devices and, the fuel injection member 54 may atomize the fuel and thereafter supply it into the prechamber 36. Further, the prechamber 36 is provided with a funnel shaped construction, as illustrated in FIG. 2. With such construction, the fuel supplied into the prechamber 36 in each fuel injection cycle may be collected at the second portion 50 of the prechamber 36. Further, the prechamber assembly 28 includes a spark plug 56 located upstream of the taper portion 48 of the prechamber 36. In an example, the wall of the prechamber 36 may be provided with a hole 58 for receiving the spark plug 56 therein. The hole 58 may include threads to fasten the spark plug 56 therein. The spark plug 56 may be so positioned in the prechamber 36, such that a tip of the spark plug 56 is proximal to the opening 52 provided at the lower region of the prechamber 36. In one example, a distributor may be coupled to the spark plug 56 for providing electrical supply for the operation of the spark plug 56.

Various embodiments disclosed herein are to be taken in the illustrative and explanatory sense, and should in no way be construed as limiting of the present disclosure.

### INDUSTRIAL APPLICABILITY

The present disclosure relates to the prechamber assembly 28. As described earlier, the prechamber 36 is configured to receive the air-fuel mixture from the main combustion chamber 20 during the compression stroke. Due to the compression stroke and owing to a substantially small cross-section of the opening 52, the air-fuel mixture entering the prechamber 36 from the main combustion chamber 20 is associated with a substantially high pressure. Moreover, all the air-fuel mixture from the main combustion chamber 20 does not enter the prechamber 36 due to the substantially small cross-section of the opening 52. As such, a minimal amount of the air-fuel mixture is forced through the opening 52 due to the movement of the piston 18 from the BDC to the TDC.

Further, the fuel entering the prechamber 36 from the fuel injection member 54 is associated with high velocity. In addition, the air-fuel mixture entering the prechamber 36 from the main combustion chamber 20 is associated with high pressure. Accordingly, the fuel mixes with the air-fuel mixture in the prechamber 36 to form a rich air-fuel mixture. Due to the position and inclination of the fuel injection member 54 in the second portion 50 of the prechamber 36, the fuel is supplied at an angle with respect to a direction at which the air-fuel mixture enters the prechamber 36. As such, the inclination of the fuel injection member 54 facilitates enhanced mixing of the fuel with the air-fuel mixture. Furthermore, while the fuel entering the prechamber 36 mixes with the air-fuel mixture already present in the prechamber 36, more air-fuel mixture enters the prechamber 36 till the end of the compression stroke, thereby forming a homogeneous rich air-fuel mixture. Before the end of the compression stroke, the homogeneous air-fuel mixture is combusted in the prechamber 36 by the spark plug 56. Owing to the volume of the prechamber 36, the homogeneous air-fuel mixture is completely and uniformly combusted in the prechamber 36.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A prechamber assembly for an engine, the prechamber assembly comprising:
a prechamber located upstream of a main combustion chamber defined in a cylinder of the engine, the prechamber adapted to receive fuel from a fuel supply system of the engine, the prechamber including:
a first portion having a first diameter;
a taper portion extending from the first portion; and
a second portion having a second diameter, the second portion extending from the taper portion, wherein the second diameter is smaller than the first diameter, and wherein the second portion includes an opening to supply the fuel into the main combustion chamber; and
a fuel injection member located downstream of the taper portion of the prechamber and fluidly connected to the second portion of the prechamber, the fuel injection member in fluid communication with the fuel supply system, wherein the fuel injector is inclined at an angle with respect to a central axis of the prechamber;
a spark plug located upstream of the taper portion of the prechamber and connected to the first portion of the prechamber,
wherein the fuel injection member is in electric communication with a controller, the controller configured to control supply of the fuel into the second portion of the prechamber to provide rich mixing of the fuel with an air-fuel mixture received from the main combustion chamber during operation of the engine.
